(19) United States
(12) Patent Application Publication
(10) Pub. No.: US 2024/0267108 A1
(43) Pub. Date: Aug. 8, 2024

(54) ELECTRONIC DEVICE AND METHOD FOR WIRELESS COMMUNICATION, AND COMPUTER READABLE STORAGE MEDIUM

(71) Applicant: Sony Group Corporation, Tokyo (JP)

(72) Inventors: Wei XU, Nanjing, Jiangsu (CN); Yuwei GAO, Nanjing, Jiangsu (CN); Zhikun WU, Beijing (CN); Chen SUN, Beijing (CN)

(73) Assignee: Sony Group Corporation, Tokyo (JP)

(21) Appl. No.: 18/563,948

(22) PCT Filed: May 27, 2022
(86) PCT No.: PCT/CN2022/095530

§ 371 Date: Nov. 24, 2023

(30) Foreign Application Priority Data
Jun. 3, 2021 (CN) 202110619275.3

(51) Int. Cl. H04B 7/06

(52) U.S. Cl. CPC H04B 7/06958

(57) ABSTRACT

The present disclosure provides an electronic device and method used for wireless communication, and a computer-readable storage medium. The electronic device comprises: a processing circuit configured to: determine a beam combination scanning indicator at least on the basis of mobile information of a user equipment, the beam combination scanning indicator being used to indicate multiple beam combinations arranged in sequence, and each beam combination comprising a direct beam sent by a base station to the user equipment and a reflection beam reflected by a large-scale intelligent reflection array to the user equipment; and providing the beam combination scanning indicator to the user equipment, so that the user equipment performs beam combination measurement according to the beam combination scanning indication.

This application claims priority to Chinese Patent Application No. 202110619275.3, titled “ELECTRONIC DEVICE AND METHOD FOR WIRELESS COMMUNICATION, AND COMPUTER READABLE STORAGE MEDIUM”, filed on Jun. 3, 2021 with the China National Intellectual Property Administration, which is incorporated herein by reference in its entirety.

### FIELD

This application relates to the technical field of wireless communications, and in particular to beam measurement in wireless communications assisted by a large intelligent surface (LIS). More specifically, the present disclosure relates to an electronic apparatus and a method for wireless communications, and a computer-readable storage medium.

### BACKGROUND

The next generation of mobile communication has proposed higher requirements in various terms of user experience rate, low latency, low power consumption, and other aspects. In order to meet the rapidly growing demand for business traffic and data rate, comprehensively improvement of performance indicators of a communication network has become a key problem confronted by 6G. In order to overcome these challenges, an LIS, realized on the basis of the latest development of meta-material technology, has become a promising alternative for enhancing performance of a wireless communication system by making use of a passive antenna arrays. The LIS is a meta-surface composed of many small passive reflectors, and is capable of modifying an incident signal and guiding a reflected wave to travel in any predetermined direction. Therefore, an ideal electromagnetic propagation environment can be obtained with a limited power consumption. For example, under the control of a base station, the LIS modifies a phase of the incident wave to obtain a reflected wave in an appropriate reflection direction, so that the signal quality of a receiver is improved.

A signal received by user equipment (UE) located on an edge of a cell is relatively weak and susceptible to interferences from adjacent cells having the same time-frequency resources as the cell. The LIS is able to provide another path to enhance a received signal. FIG. 1 shows a schematic diagram of communications of a user on a cell edge with assistance of an LIS. The mobile user equipment (UE) is located on the edge of the cell, and there is no obstacle between the UE and a base station, as shown in FIG. 1. There are two links simultaneously, namely a reflected beam via the LIS and a direct beam from the base station.

Due to movement of the UE, a previously aligned beam is no longer accurate. Therefore, it may be necessary to perform re-alignment. However, beam tracking in NR is not applicable here, and beam scanning for the base station and the LIS needs to be performed again to find an optimal beam direction.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided. The electronic apparatus includes processing circuitry, configured to: determine, at least based on mobility information of user equipment (UE), a beam combination scanning indicator which is used to indicate multiple beam combinations arranged in sequence, where each beam combination includes a direct beam which is emitted from a base station to the UE and a reflected beam which is reflected by a large intelligent surface (LIS) toward the UE; and provide the beam combination scanning indicator to the UE, so that the UE performs beam combination measurement based on the beam combination scanning indicator.

According to another aspect of the present disclosure, a method for wireless communications is provided. The method includes: determining, at least based on mobility information of user equipment (UE), a beam combination scanning indicator which is used to indicate multiple beam combinations arranged in sequence, where each beam combination includes a direct beam which is emitted from a base station to the UE and a reflected beam which is reflected by a large intelligent surface (LIS) toward the UE; and providing the beam combination scanning indicator to the UE, so that the UE performs beam combination measurement based on the beam combination scanning indicator.

According to an aspect of the present disclosure, an electronic apparatus for wireless communications is provided. The electronic apparatus includes processing circuitry, configured to: receive, from a base station, a beam combination scanning indicator which is used to indicate multiple beam combinations arranged in sequence, where each beam combination includes a direct beam which is emitted from the base station to UE and a reflected beam which is reflected by a large intelligent surface (LIS) toward the UE; and perform beam combination measurement based on the beam combination scanning indicator.

According to another aspect of the present disclosure, a method for wireless communications is provided. The method includes: receiving, from a base station, a beam combination scanning indicator which is used to indicate multiple beam combinations arranged in sequence, where each beam combination includes a direct beam which is emitted from the base station to UE and a reflected beam which is reflected by a large intelligent surface (LIS) toward the UE; and performing beam combination measurement based on the beam combination scanning indicator.

According to other aspects of the present disclosure, there are further provided computer program codes and computer program products for implementing the methods for wireless communications above, and a computer-readable storage medium having recorded thereon the computer program codes for implementing the methods for wireless communications described above.

With the electronic apparatus and the method according to the embodiments of the present disclosure, scanning of specific beam combinations of a direct beam and a reflected beam is performed under the control of the base station, reducing an overhead and delay caused by beam scanning and improving communication quality of the UE.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 shows a schematic diagram of communications of a user on a cell edge with assistance of an LIS;

FIG. 2 shows a schematic diagram of beam scanning for a single cell;

FIG. 3 shows a schematic diagram of beam scanning for multiple cells;

FIG. 4 shows a schematic diagram of sequentially performing scanning of a direct beam and scanning of a reflected beam;

FIG. 5 shows a schematic diagram of an alignment failure in a case of adopting the sequential scanning as shown in FIG. 4;

FIG. 6 is a functional block diagram illustrating an electronic apparatus for wireless communications according to an embodiment of the present disclosure;

FIG. 7 shows a schematic diagram of an initial beam combination servicing the UE;

FIG. 8 shows a schematic diagram of the UE moving out of a coverage range of an initial beam combination;

FIG. 9 shows a schematic diagram of a UE performing beam scanning based on a beam combination scanning indicator;

FIG. 10 shows a schematic diagram of a situation where a direct link does not share the same time-frequency resources with a reflective link;

FIG. 11 shows a schematic diagram of changes in quality of service of a direct link and a reflective link;

FIG. 12 shows a schematic diagram of beam scanning after movement of the UE in an example of FIG. 10;

FIG. 13 shows a schematic diagram of UE performing beam scanning based on a beam combination scanning indicator of each cell respectively;

FIG. 14 shows a schematic diagram of a scenario where a direct beam and a reflected beam of each of two cells do not share the same time-frequency resources;

FIG. 15 shows a schematic diagram of possible quality changes in a received beam of each cell;

FIG. 16 is a functional block diagram illustrating an electronic apparatus for wireless communications according to another embodiment of the present application;

FIG. 17 shows a schematic diagram of an example of an information procedure among a base station (gNB), an LIS, and UE;

FIG. 18 shows a flowchart of a method for wireless communications according to an embodiment of the present disclosure;

FIG. 19 shows a flowchart of a method for wireless communications according to another embodiment of the present disclosure;

FIG. 20 is a block diagram showing a first example of an exemplary configuration of an eNB or gNB to which the technology of the present disclosure may be applied;

FIG. 21 is a block diagram showing a second example of an exemplary configuration of an eNB or gNB to which the technology of the present disclosure may be applied;

FIG. 22 is a block diagram showing an example of an exemplary configuration of a smartphone to which the technology according to the present disclosure may be applied;

FIG. 23 is a block diagram showing an example of an exemplary configuration of a car navigation apparatus to which the technology according to the present disclosure may be applied; and

FIG. 24 is a block diagram of an exemplary block diagram illustrating the structure of a general purpose personal computer capable of realizing the method and/or device and/or system according to the embodiments of the present disclosure.

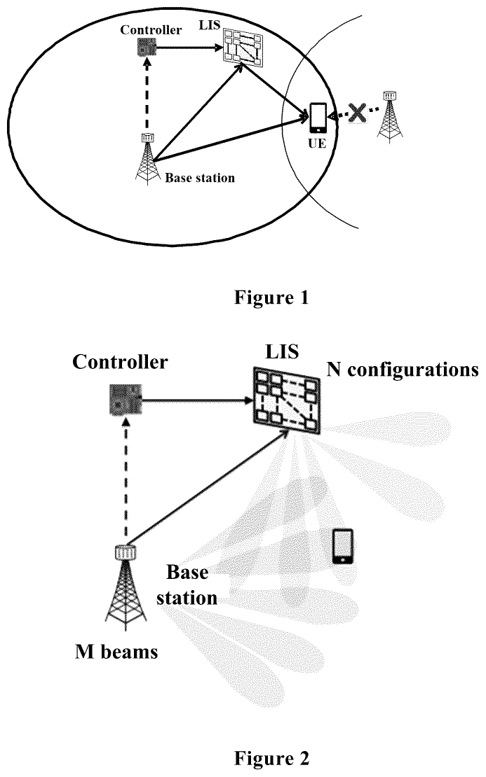

### DETAILED DESCRIPTION

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

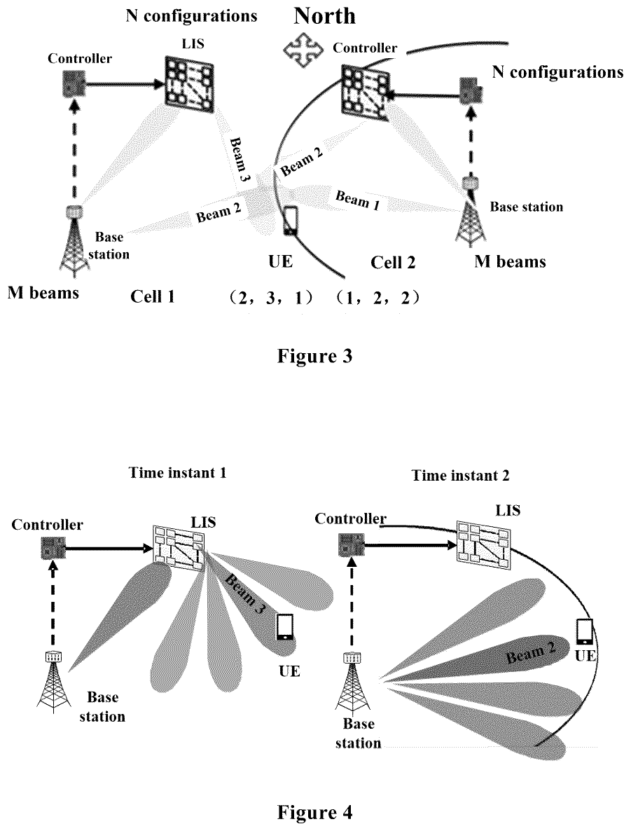

An LIS is a passive array and cannot transmit any new signal on its own. Therefore, when using the LIS for communication assistance, it is necessary for a base station to assist in beam scanning of the LIS for channel state measurement, so as to select an appropriate reflected beam. As mentioned above, a beam alignment needs to be performed again in a case that the UE moves. The beam alignment may be achieved through beam scanning. FIG. 2 shows a schematic diagram of beam scanning for a single cell. As can be seen, in a case that a base station has multiple panels and M beam directions, and an LIS has N configurations, beam measurement needs to be performed for M×N times in a case a direct link shares the same time-frequency resources with an indirect link, resulting in significant overhead loads and delay. FIG. 3 shows a schematic diagram of beam scanning for multiple cells. In this case, UE maintains connections with both cell 1 and cell 2 for communication. Similarly, a base station of each of the cells has multiple panels and M beam directions and an LIS has N configurations, and therefore beam scanning likewise results in significant overhead loads and delay. In view of this, this embodiment is intended to provide a technique that can reduce an overhead and delay due to beam scanning. Such a technique can be applied to both beam scanning for a single cell and beam scanning for multiple cells.

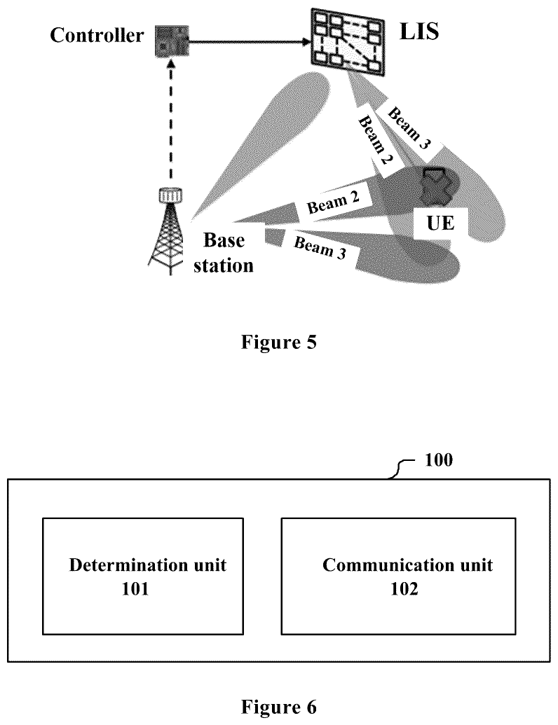

In addition, in a case that the beam scanning of a direct beam and the beam scanning of a reflected beam are carried out sequentially, alignment failure may occur due to delay, which is caused by movement of the UE. For example, in a case that after an appropriate beam is determined by the base station, when the LIS performs the beam scanning the UE has moved again, the beam already determined by the base station may no longer be applicable due to delay, and vice versa. FIG. 4 shows a schematic diagram of sequentially performing scanning of a direct beam and scanning of a reflected beam. FIG. 5 shows a schematic diagram of an alignment failure in a case of adopting the sequential scanning as shown in FIG. 4. In FIG. 4, a reflected beam 3 is determined at the time instant 1, and a direct beam 2 is determined at the time instant 2 as an appropriate beam, respectively. However, the reflected beam 3 determined at the time instant 1 is no longer applicable at the time instant 2 due to the movement of the UE (the UE has moved or is about to move out of a coverage range of the reflected beam 3). In view of this, it is proposed in this embodiment to improve an effectiveness of beam alignment by performing scanning of a beam combination composed of the direct beam and the reflected beam.

FIG. 6 shows a functional block diagram of an electronic apparatus 100 according to an embodiment of the present application. The electronic apparatus 100 includes a determination unit 101 and a communication unit 102. The determination unit 101 is configured to determine, at least based on mobility information of user equipment (UE), a beam combination scanning indicator which is used to indicate multiple beam combinations arranged in sequence. Each beam combination includes a direct beam which is emitted from a base station to the UE and a reflected beam which is reflected by an LIS toward the UE. The communication unit 102 is configured to provide the beam combination scanning indicator to the UE, so that the UE performs beam combination measurement based on the beam combination scanning indicator.

The determination unit 101 and the communication unit 102 may be implemented by one or more processing circuits. Such processing circuits may be implemented as chips or processors, for example. It should be understood that various functional units in the electronic apparatus shown in FIG. 6 are only logical modules divided based on specific functions thereof, and are not for limiting specific implementation.

The electronic apparatus 100 may be disposed on a base station side or communicatively connected to a base station, for example. The base station described in this disclosure may also be a Transmit-Receive Point (TRP) or an Access Point (AP). Here, it should be further noted that the electronic apparatus 100 may be implemented at a chip level or may be implemented at a device level. For example, the electronic apparatus 100 may operate as the base station itself and may further include external devices such as a memory, and a transceiver (not shown). The memory may store related data information and programs that the base station needs to execute to achieve various functions. The transceiver may include one or more communication interfaces to support communications with different devices (such as UE, other base stations, and the like). An implementation of the transceiver is not specifically limited here.

The determination unit 101 is configured to determine, at least based on the mobility information of the UE, a beam combination to be measured by the UE, and generate the beam combination scanning indicator. In other words, the UE no longer scans all beam combinations, but scans specific beam combinations with assistance of the base station, so as to reduce the overhead. For example, the mobility information of the UE may include a movement direction of the UE. The determination unit 101 may predict a possible position of the UE in the future based on the movement direction of the UE, and thereby determine a direct beam and a reflected beam suitable for that position and construct an appropriate beam combination.

In addition, the mobility information of the UE may further include a movement speed of the UE, for determining the possible position of UE in the future more accurately. For example, the mobility information may be acquired from the UE by the communication unit 102.

In an example, the determination unit 101 is configured to determine, based on the mobility information, whether the UE is to deviate from a current beam serving range, and determine to update a beam (i.e., perform beam alignment again) in a case of determining that the UE is to deviate from the current beam serving range. Updating the beam includes updating the direct beam and/or the reflected beam. In this example, the communication unit 102 may periodically acquire the mobility information from the UE, for example. A specific period may be configured by the base station, be a predetermined period, or be an adaptively determined period based on a current speed of the UE and the like.

In another example, the communication unit 102 is further configured to acquire a beam updating request from the UE. The beam updating request includes, for example, a request by the UE for requesting update of a beam and the mobility information of the UE. The determination unit 101 determines to update the beam in response to the beam updating request. Updating the beam includes updating the direct beam and/or the reflected beam. For example, the UE may transmit a beam updating request to the base station, in a case of detecting that the communication quality falls to a predetermined degree. For example, the communication quality may be represented by Quality of Service (QoS), which may be a Channel-Quality Indicator (CQI) or simply expressed as log 2(1+pₖ/σ²), which requires:

$$log 2 ( 1 + {p}_{k} / {σ}^{2} ) > {R}_{min , k} \qquad ( 1 )$$

In equation (1), pₖ represents a receiving power of a k-th UE, σ² represents noise power, R_{min,k} represents an individual QoS constraint for the k-th UE.

For example, when the UE detects that the receiving power does not satisfy the above mentioned condition, the UE determines that it is necessary to update the beam and thus transmits the beam updating request to the base station. The determination unit 101 determines the beam combinations to be scanned based on the beam updating request.

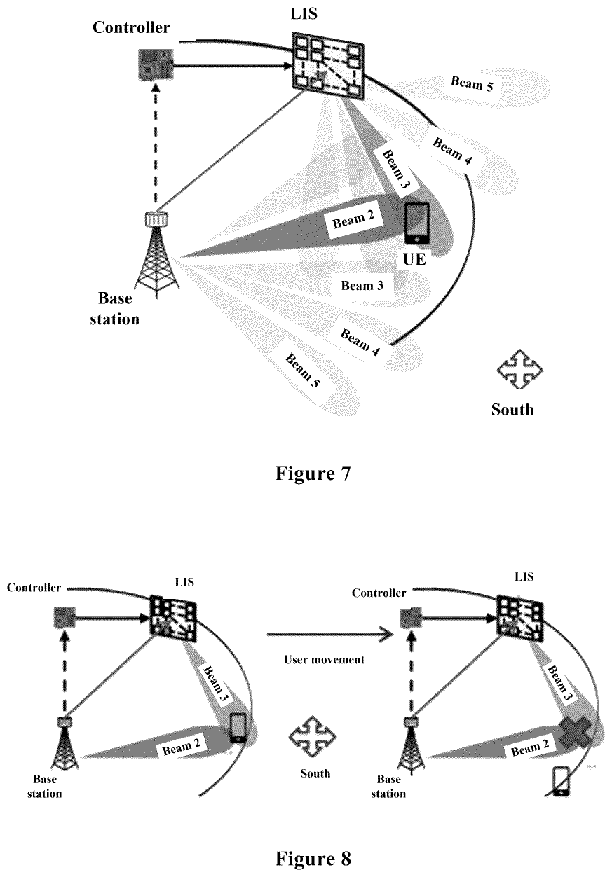

For ease of understanding, an example of the operation of determining the beam combinations to be scanned by the determination unit 101 is provided below. It is assumed that the UE is served by a single cell and the reflective link shares the same time-frequency resources with the direct link. FIG. 7 shows a schematic diagram of an initial beam combination serving the UE. As can be seen, the UE initially uses the direct beam 2 and the reflected beam 3 for communications, which may be represented as a beam combination (2, 3) for example. Due to the sharing of the same time-frequency resources between the reflective link and the direct link, the UE cannot determine changes in the quality of service of the reflective link and the direct link individually. To update the beam, it is required to perform beam scanning on a beam combination basis. For example, it is assumed that the UE moves southward and such a movement direction is fed back to the base station. For example, it is determined to update beams (in this example, updating both the direct beam and the reflected beam) through one of the two manners mentioned above (i.e., determined by the base station or determined by the UE). That is, the UE has already moved out of the coverage range of the initial beam combination, as shown in FIG. 8. In this case, the determination unit 101 preferentially selects three beam combinations in a southwest direction, a southeast direction and a south direction for scanning, since a probability of obtaining an optimal beam combination in these directions is high.

For example, the beam combination scanning indicator determined by the determination unit 101 may include a scanning sequence list of beam combinations. In a case that the UE is served by a single cell, each entry in the scanning sequence list of beam combinations includes a beam index of a direct beam and a beam index of a reflected beam. Table 1 below shows an example of the scanning sequence list of beam combinations corresponding to an example in FIG. 7.

TABLE 1

| Direction | Index pair |
|---|---|
| South | (3, 2) |
| Southwest | (2, 2) |
| Southeast | (3, 3) |
| Northwest | (1, 2) |
| Northeast | (1, 4) |
| West | (2, 4) |
| East | (1, 2) |
| North | (1, 4) |

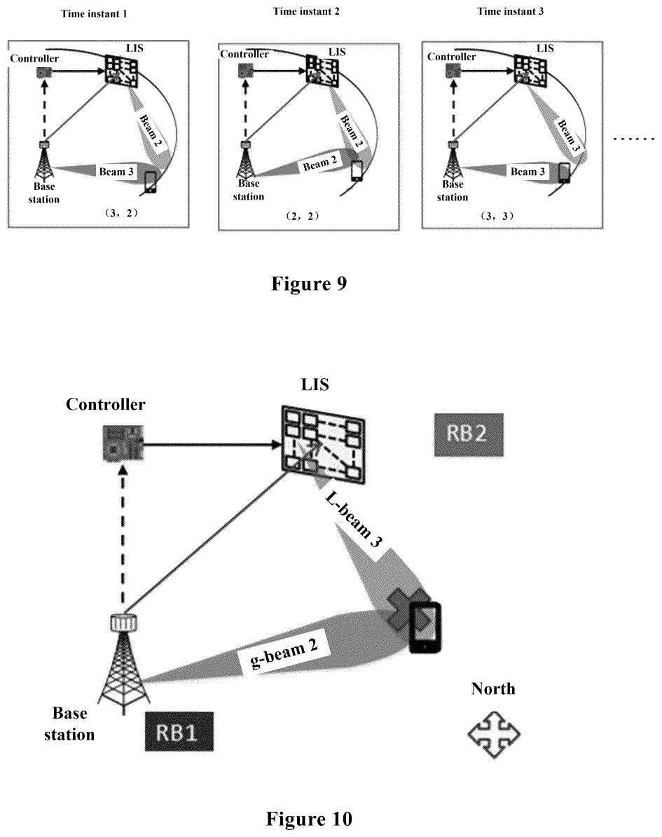

In this example, the beam combination scanning indicator includes a predetermined number of index pairs (as shown in the second column of Table 1). The predetermined number may be specified by the base station. In addition, the beam combination scanning indicator may further include information indicating a movement direction of the UE corresponding to each index pair, namely the information in the first column of Table 1. Upon receiving the above mentioned beam combination scanning indicator, the UE first scans the beam combination (3, 2), then scans (2, 2), and so on. FIG. 9 shows a schematic diagram of the UE performing beam scanning based on the beam combination scanning indicator. In FIG. 9, beam scanning based on the first three index pairs is shown. As can be seen, with the beam combination scanning indicator shown in Table 1, the UE needs to scan only 8 beam combinations or less; while in a case of scanning all possible beam combinations, the scanning need to be performed 25 times (assuming that there are 5 possible directions for each of the direct beam and the reflected beam). Therefore, the overhead of beam scanning based on the beam combination scanning indicator according to the embodiment is significantly reduced.

In addition, the electronic apparatus 100 may further include a memory, configured to store a correspondence among a movement direction of the UE, a to-be-scanned beam and a current beam. The determination unit 101 is configured to determine the beam combination scanning indicator based on the mobility information and the correspondence. In this way, the computational load on the base station can be reduced.

On the other hand, in a case that the direct link does not share the same time-frequency resources with the reflective link, the UE may distinguish changes in the quality of service (such as receiving power) of the two links from each other, and estimate a movement direction of the UE based on the changes in the quality of service of the two links. In addition, the UE may further report, to the base station, information of the changes in the quality of service. For example, the UE may report, to the base station, information related to a link with reduced quality of service. Correspondingly, the communication unit 102 may acquire, from the UE, the information on changes in the quality of service of the direct link and/or reflective link. The determination unit 101 determines, based on the information, the beam combination scanning indicator, so that the UE performs beam scanning only for the link with reduced receiving power. For example, the determination unit 101 may determine a beam scanning combination such that a current beam with good quality of service remains unchanged. The UE only needs to scan the beam corresponding to the link with decreased quality of service.

For ease of understanding, FIG. 10 shows a schematic diagram of a situation where a direct link does not share the same time-frequency resources with a reflective link. FIG. 11 shows a schematic diagram of changes in quality of service of a direct link and a reflective link. It is assumed that the direct link occupies a time-frequency resource block RB1 and the reflective link occupies a time-frequency resource block RB2. In FIG. 10, g-beam represents the direct beam, and L-beam represents the reflected beam. In FIG. 11, darkness of a shadow is used to indicate the strength of a received signal. A darker shadow indicates that the received signal is stronger and the quality of service is better. As can be seen, after movement of the UE, there are three situations for the strength of the received signal, including: the quality of service of the direct link and the quality of service of the reflective link are both decreased, as shown in the 4th row in FIG. 11; the quality of service of the direct link is decreased, and the quality of service of the reflective link remains good, as shown in the 2^{nd} row in FIG. 11; the quality of service of the reflective link is decreased, and the quality of service of the direct link remains good, as shown in the 3^{rd} row in FIG. 11.

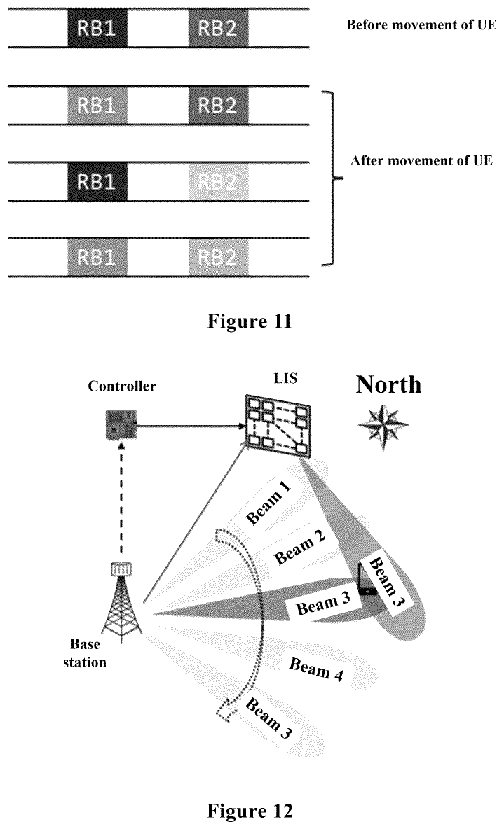

FIG. 12 shows a schematic diagram of beam scanning after the movement of the UE in the example of FIG. 10. In FIG. 12, the UE measures the power of a received beam, and determines that a reflected beam 3 still remains good QoS and a direct beam 2 is weakened. Therefore, the UE reports this situation to the base station. The determination unit 101 on the base station side determines, based on the situation, that only the beam of the direct link needs to be re-scanned and the reflected beam 3 can be maintained unchanged, and thereby determines a corresponding beam combination scanning indicator. The communication unit 102 transmits the beam combination scanning indicator to the UE. It can be understood that the beam combination scanning indicator here may still use the aforementioned scanning sequence list of beam combinations, but the beam index of the reflected beam in each entry remains unchanged or is a specific value. Alternatively, all direct beams may also be scanned. Although the description here takes an example of scanning only the direct beam, it is not limited thereto. It is possible to scan only the reflected beam and maintain the direct beam unchanged.

Correspondingly, the determination unit 101 may be further configured to determine whether a direct link between the base station and UE shares the same time-frequency resources with a reflective link via the LIS between the base station and the UE; and determine the beam combination scanning indicator so that the UE performs beam scanning just for a link with reduced receiving power, in a case of determining that the direct link does not share the same time-frequency resources with the reflective link.

Furthermore, the communication unit 102 is further configured to control the base station and the LIS to scan the beam combinations of the direct beams and the reflected beams based on the beam combination scanning indicator. For example, the base station may perform beam scanning by transmitting a reference signal using a beam. For example, in the example shown in above Table 1, the communication unit 102 is configured to control the base station to scan direct beams in an order of beams {3, 2, 3, 1, 1, 2, 1, 1}, and control the LIS to scan reflected beams, synchronously with the base station, in an order of beams {2, 2, 3, 2, 4, 4, 2, 4}. It can be understood that in the case that beam scanning is only performed for one of the direct link and the reflective link, the communication unit 102 controls only one of the base station and the LIS to perform beam scanning according to the beam combination scanning indicator in this case.

After receiving the beam combinations, the UE measure the beam combinations. The communication unit 102 is further configured to acquire, from the UE, information of a feedback beam combination determined by the UE through measurement on the beam combinations.

For example, the feedback beam combination includes one of the following: an optimal beam combination; and a beam combination of which the communication quality meets a predetermined requirement. For example, the UE measures strength of a received signal of each beam combination and calculates a signal to interference and noise ratio (SINR). For example, the SINR may be calculated as follows:

$${SINR}_{i , j} = \frac{{P}_{i , j}}{{\sum }_{{c}^{′} \neq c} {P}_{{c}^{′}} + {P}_{N}} \qquad ( 2 )$$

In equation (2), i represents the direct beam, j represents the reflected beam, P_{i,j} represents a signal power received by the UE for a beam combination (i,j), Σ_{c′≠c}P_{c′} represents interferences from a cell other than the current cell (which is 0 in a case that only a single cell is considered), and P_{N} represents the noise power.

Depending on a movement speed of the UE, the UE may report, to the base station, the optimal beam combination, such as a beam combination with the highest SINR, or may report to the base station upon detecting a beam combination which has a SINR higher than a predetermined threshold. Specifically, in a case that the UE moves at a low speed, the UE may perform measurement on all beam combinations indicated in the beam combination scanning indicator, and report, to the base station, information of a beam combination with the strongest signal strength or a beam combination with communication quality satisfying a predetermined requirement. In a case that the UE moves at a high speed, in order to meet the requirement for real-time property, the UE may report to the base station immediately when detecting a beam combination whose communication quality meets the requirement, without waiting for the completing of the scanning. For example, in the example in Table 1, in a case that the UE moves at a high speed and detects that the SINR of the first beam combination (3, 2) is higher than a threshold SINR, the UE reports information of that beam combination to the base station.

For example, the optimal beam combination i_{i,j} may be determined as follows:

$${i}_{i , j} {i}_{i , j} = arg {max}_{i , j = 1 , 2 , ...} {SINR}_{i , j} \qquad ( 3 )$$

Alternatively, the UE may further record a beam combination having communication quality satisfying the predetermined requirement as follows:

$${i}_{i , j} = \{ ( i , j ) \vert {SINR}_{i , j} > {SINR}_{min , c} \} \qquad ( 4 )$$

In equation (4), SINR_{min,c} represents a minimum SINR that meets a requirement of quality of service.

The determination unit 101 determines, based on the information of the feedback beam combination, a beam combination to be used by the UE after beam updating. The communication unit 102 controls, based on the beam combination, a direction of the direct beam from the base station and a direction of the reflected beam from the LIS. In this way, the UE can acquire a stronger received beam.

The communication unit 102 may be configured to acquire the information of the feedback beam combination through a physical uplink control channel (PUCCH) or MAC CE. For example, the information of the feedback beam combination may include a beam index pair of the feedback beam combination, and it can further include a measurement result corresponding to the feedback beam combination. For example, the information of the feedback beam combination may be transmitted through the PUCCH in a case of a small data volume; and may be transmitted through the MAC CE in a case of a large data volume.

In addition, the communication unit 102 may acquire the information of the feedback beam combination in an explicit manner or an implicit manner. The explicit manner includes, for example, feeding back through signaling as mentioned above. In the implicit manner, for example, the communication unit 102 determines the information of the feedback beam combinations based on a time instant at which the UE transmits feedback. The beam scanning is carried out in an order of beam combinations determined by the base station. Therefore, when it is defined that different feedback time instants correspond to different beam combinations, the information of the feedback beam combination can be provided implicitly by using time instants when feedback is transmitted.

The above description mainly focuses on the situation of a single cell, which is similarly applicable to a situation of multiple cells. The following description is made by taking an example in which UE is covered by multiple cells, as shown in FIG. 3.

In this example, the determination unit 101 is further configured to determine whether the UE is served by multiple cells. The communication unit 102 is configured to cooperate with a base station of another cell to perform synchronous transmission and perform beam combination scanning respectively, in a case that it is determined that the UE is served by multiple cells. For example, the communication unit 102 may interchange the beam combination scanning indicator with the base station in another cell.

Here, the UE may be in a dual-connection mode. That is, all radio resource control (RRC) signaling messages and functions required by the UE are managed by a primary base station MeNB (assumed to be a base station gNB1 of cell 1), and the primary base station and a secondary base station (assumed to be a base station gNB2 of cell 2) coordinate to perform a Radio resource management (RRM) function.

In a case that the UE is served by multiple cells, it is necessary to cooperate among multiple cells when performing beam scanning for beam updating, in order to ensure that the cells determine an actual movement direction of the UE consistently. The cells cooperate with each other to perform beam scanning in a one-to-one manner according to the beam combination scanning indicator of each cell.

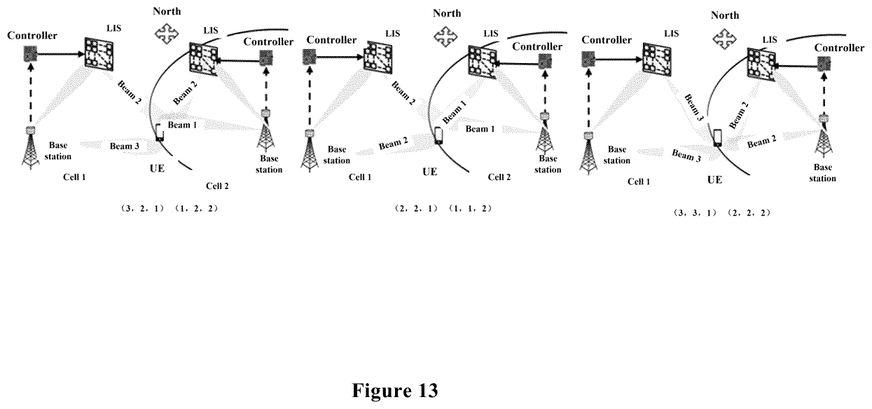

Returning back to the example shown in FIG. 3, an initial beam pair for cell 1 is (2,3), namely, direct beam 2 and reflection beam 3, denoted here as (2,3,1), where the third parameter represents an identifier of the cell. Similarly, an initial beam pair for cell 2 is (1,2,2). In a case that beam updating is required due to changes in a position of the UE, beam scanning needs to be performed. FIG. 13 shows a schematic diagram of the UE performing beam scanning based on a beam combination scanning indicator of each cell respectively.

Base stations of cell 1 and cell 2 respectively determine beam combination scanning indicators as mentioned above. The beam combination scanning indicator includes a scanning sequence list of beam combinations, an example of which is as shown in Table 2 below. Each entry in the scanning sequence list of beam combinations includes a beam index of a direct beam, a beam index of a reflected beam, and information of an identifier of a corresponding cell.

TABLE 2

| | |
|---|---|
| Cell 1 | Cell 2 |

| Direction | Index pair | ←→ | Direction | Index pair |
|---|---|---|---|---|
| South | (3, 2, 1) | ←→ | Southwest | (1, 2, 2) |
| Southwest | (2, 2, 1) | ←→ | West | (1, 1, 2) |
| Southeast | (3, 3, 1) | ←→ | South | (2, 2, 2) |
| Northwest | (1, 2, 1) | ←→ | Southeast | (1, 3, 2) |
| Northeast | (1, 4, 1) | ←→ | Northwest | (2, 1, 2) |
| West | (2, 4, 1) | ←→ | Northeast | (1, 2, 2) |
| East | (1, 2, 1) | ←→ | East | (1, 3, 2) |
| North | (1, 4, 1) | ←→ | North | (1, 1, 2) |

As shown in FIG. 13, the base station of cell 1 first controls to transmit direct beam 3 and reflected beam 2 to the UE, and simultaneously the base station of cell 2 controls to transmit direct beam 1 and reflected beam 2 to the UE. The UE receives these beams. Then, the base station of cell 1 and the base station of cell 2 continue to control to scan the beam pairs according to the sequence shown in Table 2.

In an example, different cells (such as above mentioned cell 1 and cell 2) use the same time-frequency resources for beam scanning (such as transmitting a reference signal through beams). In this case, a signal to interference and noise ratio of a beam combination measured by UE is:

$${SINR}_{i , j , c} = \frac{{P}_{i , j , c}}{{\sum }_{{c}^{′} \neq c} {P}_{{c}^{′}} + {P}_{N}} \qquad ( 5 )$$

In equation (5), (i, j, c) represents an index pair in Table 2, that is, i represents the direct beam of cell c, j represents the reflected beam of cell c, P_{N} represents the noise power, and P_{c′} represents the interference power from another cell c′. In the example in FIG. 13, c and c′ may be 1 or 2, respectively.

Similarly, the UE may record an optimal beam combination as follows:

$${i}_{i , j , c} = arg {max}_{i , j , c - 1 , 2 , ...} {SINR}_{i , j , c} \qquad ( 6 )$$

Alternatively, the UE may also record a beam combination whose communication quality satisfies a predetermined requirement:

$${i}_{i , j , c} = \{ ( i , j , c ) \vert {SINR}_{i , j , c} > {SINR}_{min , c} \} \qquad ( 7 )$$

In equation (7), SINR_{min,c} represents a minimum SINR that satisfies a requirement of quality of service.

In another example, different cells use different time-frequency resources for beam scanning. In this case, the signal to interference and noise ratio of a beam combination measured by the UE is:

$${SINR}_{i , j , {c}_{1} , m , n , {c}_{2}} = \frac{{P}_{i , j , {c}_{1}} + {P}_{m , n , {c}_{2}}}{{P}_{N}} \qquad ( 8 )$$

The UE may record an optimal beam combination as follows:

$$( i , j , {c}_{1} ) , ( m , n , {c}_{2} ) = arg {max}_{i , j , {c}_{1} , m , n , {c}_{2}} {SINR}_{i , j , {c}_{1} , m , n , {c}_{2}} \qquad ( 9 )$$

Alternatively, UE may also record a beam combination whose communication quality satisfies a predetermined requirement:

$$i = \{ ( i , j , {c}_{1} ) , ( m , n , {c}_{2} ) \vert {SINR}_{i , j , {c}_{1} , m , n , {c}_{2}} > {SINR}_{min} \} \qquad ( 10 )$$

In equation (10), SINRₘᵢₙ represents a minimum SINR that satisfies a requirement of quality of service.

As mentioned above, the type of a beam combination reported by the UE depends on the movement speed of the UE, and a specific reporting method may be configured differently and is not repeated here. For example, in the example in Table 2, in a case that the UE moves at a high speed, beam combinations (3, 2, 1) and (1, 2, 2) are reported to the base station (primary base station) as feedback beam combinations in a case of determining the scanning of the first beam combination, namely (3, 2, 1) and (1, 2, 2), satisfies the requirement of communication quality. In a case that the UE moves at a low speed, optimal beam combinations (3, 3, 1) and (2, 2, 2) may be selected and reported to the base station after completing scanning of the beam combinations listed in Table 2.

In addition, in a case that the UE is served by multiple cells and the direct beam does not share the same time-frequency resources with the reflected beams for each of the cells, the UE may distinguish changes in quality of service (such as receiving power) of the direct link and the reflective link, as described for the case where UE is served by a single cell. Thereby, the movement direction of the UE can be pre-estimated based on the changes in the quality of service of the two links. The UE may further report, to the base station, information of changes in the quality of service. For example, the UE may report, to the base station, information related to links with reduced quality of service, so that the base station performs beam scanning just for the link with the reduced quality of service. Therefore, the overhead is further reduced.

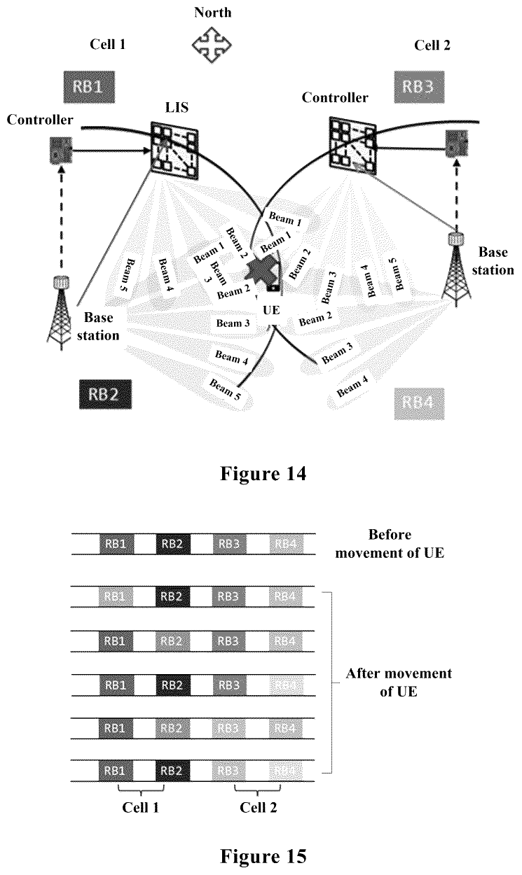

For ease of understanding, FIG. 14 shows a schematic diagram of a scenario where a direct beam does not share the same time-frequency resources with a reflected beam for both of two cells. When the UE moves, the possible quality changes of received beams in the cells are as shown in FIG. 15. In FIG. 15, the darkness of a shadow is used to indicate a magnitude of strength of a received signal. A darker shadow indicates that the received signal has higher strength, and thereby has better quality of service.

In summary, the electronic apparatus 100 according to this embodiment is configured to perform, under the control of the base station, beam scanning of specific beam combinations of direct beams and reflected beams, so that the overhead and delay caused by the beam scanning is reduced and the communication quality of the user equipment is improved.

### Second Embodiment

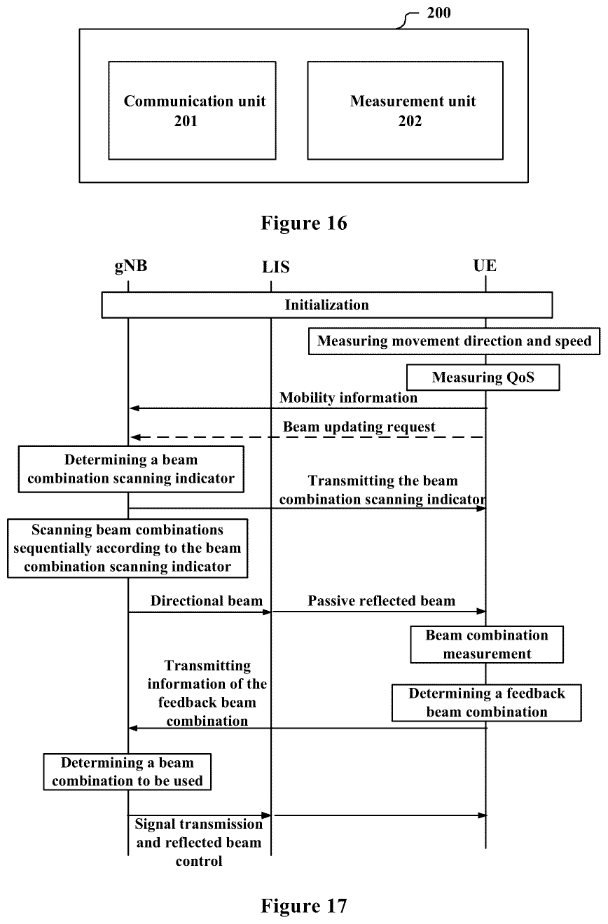

FIG. 16 shows a functional block diagram of an electronic apparatus 200 according to another embodiment of the present application. Reference is made to FIG. 16. The electronic apparatus 200 includes a communication unit 201 and a measurement unit 202. The communication unit 201 is configured to receive, from a base station, a beam combination scanning indicator which is used to indicate multiple beam combinations arranged in sequence. Each beam combination includes a direct beam which is emitted from the base station to UE and a reflected beam which is reflected by a large intelligent surface (LIS) to the UE. The measurement unit 202 is configured to perform beam combination measurement based on the beam combination scanning indicator.

The communication unit 201 and the measurement unit 202 may be implemented by one or more processing circuits. Such processing circuits may be implemented as chips or processors, for example. It should be understood that various functional units in the electronic apparatus shown in FIG. 16 are only logical modules determined based on specific functions thereof, and are not for limiting specific implementation.

The electronic apparatus 200 may be disposed on UE side or communicatively connected to UE, for example. Here, it should be noted that the electronic apparatus 200 may be implemented at a chip level or at a device level. For example, the electronic apparatus 200 may operate as the UE itself and may further include external devices such as a memory, and a transceiver. The memory may store related data information and programs that the UE needs to execute to achieve various functions. The transceiver may include one or more communication interfaces to support communications with different devices (such as a base station, other UE, and the like). An implementation of the transceiver is not specifically limited here.

For example, in a case that the UE is on an edge of a cell, both a direct link and a reflective link via the LIS may be adopted for enhancing strength of a received signal, in order to improve communication quality. In a case that the communication quality is reduced due to movement of the UE and beam updating is required, the base station may determine beam combinations to be scanned and generate a beam combination scanning indicator, as described in the first embodiment, for example. The communication unit 201 is configured to acquire, from the base station, the beam combination scanning indicator. The measurement unit 202 is configured to perform beam combination measurement based on the beam combinations indicated by the beam combination scanning indicator.

For example, the beam combination scanning indicator may include a scanning sequence list of beam combinations. In a case that the UE is served by a single cell, each entry in the scanning sequence list of beam combinations includes a beam index of a direct beam and a beam index of a reflected beam. In a case that the UE is served by multiple cells, each entry in the scanning sequence list of beam combinations includes a beam index of a direct beam, a beam index of a reflected beam, and information of an identifier of a corresponding cell. It should be understood that the beam combination scanning indicator may be in another form, and is not limited thereto.

In addition, the communication unit 201 is further configured to provide, to the base station, information of a feedback beam combination determined through measurement on the beam combinations. As mentioned above, the feedback beam combination may include one of the following: an optimal beam combination; a beam combination of which communication quality meets a predetermined requirement. For example, in a case that the UE moves at a high speed, the requirement on a speed of the beam updating is high, and a delay caused by beam scanning should be reduced as much as possible. Therefore, the UE may report information of a beam combination whose communication quality satisfies the requirement to the base station through the communication unit 201 immediately when the beam combination is detected. On the contrary, in a case that the UE moves at a low speed, the UE may complete the measurement on all beam combinations indicated by the beam combination scanning indicator and select an optimal beam for reporting.

The communication unit 201 may provide information of a feedback beam combination, for example, through PUCCH or MAC CE. For example, the information of the feedback beam combination may be transmitted through the PUCCH in a case of a small data volume; and may be transmitted through the MAC CE in a case of a large data volume.

On the other hand, the communication unit 201 may provide the information of the feedback beam combination information in an explicit manner or an implicit manner. The explicit manner includes, for example, a manner through signaling as mentioned above. The implicit manner includes, for example, providing the information of the feedback beam combination through a time instant at which feedback is transmitted. Specific description is provided in the first embodiment and is not repeated here.

In addition, the communication unit 201 is further configured to report mobility information to the base station, so that the base station determines the beam combination scanning indicator based on the mobility information. The mobility information includes at least a movement direction of the UE. In addition, the mobility information may further include a movement speed of the UE.

In an example, the communication unit 201 may report the mobility information periodically. The base station determines, based on the mobility information, whether the UE is about to move out of a coverage range of a current beam, for example, and thereby determines whether to perform beam updating. In another example, a beam updating request may be triggered by the UE. For example, the communication unit 201 may be configured to transmit, to the base station, a beam updating request for requesting the base station to update a beam, in a case that the communication quality falls to a predetermined degree. Updating the beam includes updating a direct beam and/or a reflected beam. For example, the UE may detect quality of service and transmit the beam updating request to the base station in a case that the quality of service is below a threshold.

The measurement unit 202 is further configured, for example, to determine whether a direct link between the base station and the UE shares the same time-frequency resources with a reflective link via the LIS between the base station and the UE, and perform beam scanning only for a link with reduced receiving power in a case of determining that the direct link does not share the same time-frequency resources with the reflective link. In a case that the direct link does not share the same time-frequency resources with the reflective link, the UE may distinguish which link has a decreased communication quality. The communication unit 201 may report information of changes in communication quality to the base station. For example, the UE may report information related to the link having reduced communication quality to the base station. In this way, the base station may determine the beam combination scanning indicator, so that the beam scanning is performed only for the link with reduced communication quality, and a beam of the other link is maintained.

In addition, the UE may also be served by multiple cells. In this case, the measurement unit 202 performs beam combination measurement for each of the cells based on the beam combination scanning indicator from the corresponding cell, respectively. It can be understood that in a case that beam scanning for multiple cells share the same time-frequency resources with each other, the measurement unit 202 measures a combined receiving power of multiple beam combinations from the multiple cells. In a case that beam scanning for multiple cells does not share the same time-frequency resources with each other, the measurement unit 202 may distinguish receiving powers of beam combinations from different cells. Furthermore, in a case that the direct link and the reflective link of each cell do not share the same time-frequency resources with each other, the measurement unit 202 may distinguish beam reception strength of the direct link and the reflective link from the corresponding cell.

In summary, the electronic apparatus 200 according to this embodiment performs the beam scanning by performing measurement on specific beam combinations of direct beams and reflected beams under the control of the base station, reducing the overhead and delay caused by the beam scanning and improving the communication quality of the user equipment.

For ease of understanding, FIG. 17 shows a schematic diagram of an example of an information procedure among a base station (gNB), an LIS, and UE. As shown in FIG. 17, after completing initialization, the UE measures a movement direction and a movement speed of the UE, and detects the QoS of the UE. The UE may report the measured mobility information periodically to the base station which determines to perform beam updating. Alternatively, the UE may determine when it is necessary to perform the beam updating itself based on a decrease in the QoS, and transmit a beam updating request to the base station. Regardless of through which of the manners, in a case that the beam updating is determined to be performed, the base station determines a beam combination scanning indicator at least based on the mobility information. The beam combination scanning indicator limits beam combinations to be scanned by the UE in sequence. Next, the base station transmits the beam combination scanning indicator to the UE and performs control to sequentially scan the beam combinations according to the beam combination scanning indicator, including transmitting a direct beam by the base station while reflecting a beam by the LIS according to a direction configured by the base station through the controller. The UE performs measurement on the beam combinations and determines a feedback beam combination, such as an optimal beam combination or a beam combination of which the communication quality meets a predetermined requirement. Then, the UE transmits information of the feedback beam combination to the base station. The base station determines, based on the feedback beam combination, a beam combination to be used; and perform, based on the determined beam combination, signal transmission and control of a reflection direction of the LIS. In this way, the UE performs communication in a direction of the updated direct beam and reflection beam.

It should be understood that FIG. 17 is only an example, and is not restrictive.

### Third Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

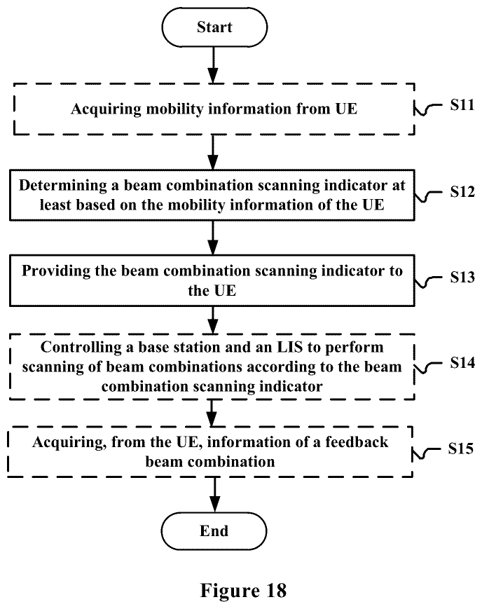

FIG. 18 shows a flowchart of a method for wireless communications according to an embodiment of the present application. The method includes: determining, at least based on mobility information of user equipment (UE), a beam combination scanning indicator which is used to indicate multiple beam combinations arranged in sequence (S12), where each beam combination includes a direct beam which is emitted from a base station to the UE and a reflected beam which is reflected by a large intelligent surface (LIS) toward the UE; and providing the beam combination scanning indicator to the UE, so that the UE performs beam combination measurement based on the beam combination scanning indicator (S13). This method may be performed on a base station side, for example.

For example, the beam combination scanning indicator may include a scanning sequence list of beam combinations. In a case that the UE is served by a single cell, each entry in the scanning sequence list of beam combinations includes a beam index of a direct beam and a beam index of a reflected beam. In a case that the UE is served by multiple cells, each entry in the scanning sequence list of beam combinations includes a beam index of a direct beam, a beam index of a reflected beam, and information of an identifier of a corresponding cell.

In addition, as shown in a dashed line block in FIG. 18, the method may further include a step S11 of acquiring mobility information from the UE. For example, the mobility information may be acquired periodically from the UE. The mobility information includes at least a movement direction of the UE. The mobility information may further include a movement speed of the UE. Step S12 may include: determining, based on the mobility information, whether the UE is to deviate from a current beam serving range, and determining to update a beam in a case of determining that the UE is to deviate from the current beam serving range. Updating the beam may include updating the direct beam and/or the reflected beam.

In an example, the step S11 may further include acquiring a beam updating request from the UE. It is determined in step S12 to update the beam in response to the beam updating request.

Although not shown in the figure, the method may further include a step of storing a correspondence among a movement direction of the UE, a to-be-scanned beam and a current beam. In step S12, the beam combination scanning indicator may be determined based on the mobility information and the correspondence.

As shown in another dashed line block in FIG. 18, the method may further include a step S14 of controlling the base station and the LIS to perform scanning of beam combinations of the direct beams and the reflected beams according to the beam combination scanning indicator.

As shown in another dashed line block in FIG. 18, the method may further include a step S15 of acquiring, form the UE, information of a feedback beam combination determined by the UE through measurement on the beam combinations. The feedback beam combination includes, for example, one of the following: an optimal beam combination; and a beam combination of which communication quality meets a predetermined requirement. In step S15, the information of the feedback beam combination may be obtained through PUCCH or MAC CE. On the other hand, the information of the feedback beam combination may be acquired in an explicit manner or an implicit manner. For example, the information of the feedback beam combination may be determined based on a time instant at which the UE transmits feedback.

In addition, the method further includes the following steps: determining, based on the information of the feedback beam combination, a beam combination to be used by the UE after beam updating, and controlling, based on the beam combination, a direction of the direct beam from the base station and a direction of the reflected beam from the LIS.

The method may further include: determining whether a direct link between the base station and the UE shares the same time-frequency resources with a reflective link via the LIS between the base station and the UE; and determining the beam combination scanning indicator so that the UE performs beam scanning just for a link with reduced receiving power, in a case of determining that the direct link does not share the same time-frequency resources with the reflective link.

The method may further include: determining whether the UE is served by multiple cells, and cooperate with a base station in another cell to perform synchronous transmission and perform beam combination scanning respectively, in a case of determining that the UE is served by multiple cells, where the beam combination scanning indicator may be interchanged with a base station in another cell.

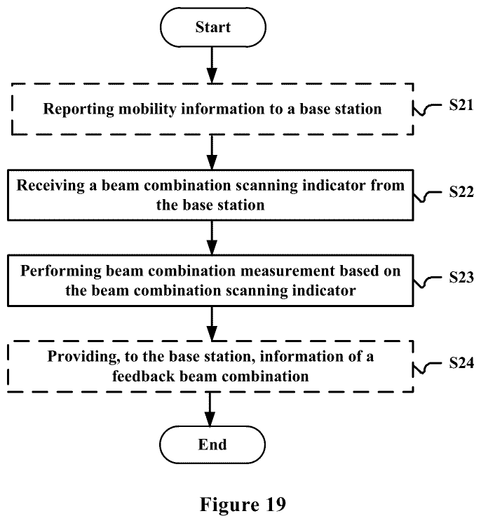

FIG. 19 shows a flowchart of a method for wireless communications according to another embodiment of the present disclosure. The method includes: receiving, from a base station, a beam combination scanning indicator (S22) which is used to indicate multiple beam combinations arranged in sequence, where each beam combination includes a direct beam which is emitted from the base station to UE and a reflected beam which is reflected by a large intelligent surface (LIS) toward the UE; and performing beam combination measurement based on the beam combination scanning indicator (S23). This method may be executed on UE side, for example.

For example, the beam combination scanning indicator may include a scanning sequence list of beam combinations. In a case that the UE is served by a single cell, each entry in the scanning sequence list of beam combinations includes a beam index of a direct beam and a beam index of a reflected beam. In a case that the UE is served by multiple cells, each entry in the scanning sequence list of beam combinations includes a beam index of a direct beam, a beam index of a reflected beam, and information of an identifier of a corresponding cell.

As shown in a dashed line block in FIG. 19, the method may further include a step S21: reporting mobility information to the base station, so that the base station determines the beam combination scanning indicator at least based on the mobility information, where the mobility information at least includes a movement direction of the UE. The mobility information may further include a movement speed of the UE. In step S21, the mobility information may be reported periodically.

In addition, step S21 may further include: transmitting a beam updating request to the base station in a case that communication quality falls to a pre-determined degree, to request the base station to update a beam, and updating the beam includes updating the direct beam and/or the reflected beam.

In addition, as shown in another dashed line block in FIG. 19, the method may further include a step S24: providing, to the base station, information of a feedback beam combination determined through measurement on the beam combinations. The feedback beam combination includes, for example, one of the following: an optimal beam combination; and a beam combination of which communication quality meets a predetermined requirement. In step S24, the information of the feedback beam combination may be provided through PUCCH or MAC CE. On the other hand, the information of the feedback beam combination may be provided in an explicit manner or an implicit manner. For example, the information of the feedback beam combination information may be provided through a time instant at which a feedback is transmitted.

The method may further include: determining whether a direct link between the base station and the UE shares the same time-frequency resources with a reflective link via the LIS between the base station and the UE, and performing beam scanning just for a link with reduced receiving power, in a case of determining that the direct link does not share the same time-frequency resources with the reflective link.

In addition, in a case that the UE is served by multiple cells, the method includes: performing beam combination measurement for each of the cells, based on a beam combination scanning indicator from the cell, respectively. In a case that beam scanning for the cells shares the same time-frequency resources, a combined receiving power of multiple beam combinations of the multiple cells is measured.

Note that the above methods may be combined or used separately, details of which are described in the first to second embodiments, and are not repeated here.

The technology of the present disclosure is applicable to various products.

The electronic apparatus 100 may be implemented as various types of base stations. The base stations may be implemented as any type of evolved node B (eNB) or gNB (5G base station). The eNB includes a macro eNB and a small eNB, for example. The small eNB may be an eNB such as a pico eNB, a micro eNB and a home (femto) eNB that covers a cell smaller than a macro cell. The situation is similar to the gNB. Alternatively, the base station may also be implemented as a base station of any other type, such as a NodeB and a base transceiver station (BTS). The base station may include a main body (that is also referred to as a base station device) configured to control wireless communications, and one or more remote radio heads (RRH) arranged in a different place from the main body. In addition, various types of user equipment each may operate as the base station by performing functions of the base station temporarily or semi-permanently.

The electronic apparatus 200 may be implemented as various types of user equipment. The user equipment may be implemented as a mobile terminal (such as a smartphone, a tablet personal computer (PC), a notebook PC, a portable game terminal, a portable/dongle type mobile router, and a digital camera), or an in-vehicle terminal (such as a car navigation apparatus). The user equipment may also be implemented as a terminal (that is also referred to as a machine type communication (MTC) terminal) that performs machine-to-machine (M2M) communication. Furthermore, the user equipment may be a wireless communication module (such as an integrated circuit module including a single die) mounted on each of the terminals.

### Application Example of a Base Station

### First Application Example

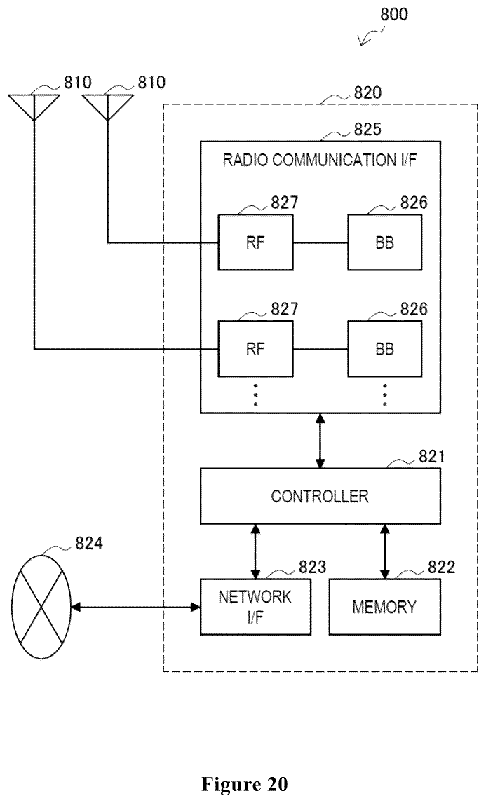

FIG. 20 is a block diagram illustrating a first example of an exemplary configuration of an eNB or gNB to which the technology according to the present disclosure may be applied. It should be noted that the following description is given by taking the eNB as an example, which is also applicable to the gNB. An eNB 800 includes one or more antennas 810 and a base station apparatus 820. The base station apparatus 820 and each of the antennas 810 may be connected to each other via a radio frequency (RF) cable.

Each of the antennas 810 includes a single or multiple antennal elements (such as multiple antenna elements included in a multiple-input multiple-output (MIMO) antenna), and is used for the base station apparatus 820 to transmit and receive wireless signals. As illustrated in FIG. 20, the eNB 800 may include the multiple antennas 810. For example, the multiple antennas 810 may be compatible with multiple frequency bands used by the eNB 800. Although FIG. 20 illustrates the example in which the eNB 800 includes the multiple antennas 810, the eNB 800 may include a single antenna 810.

The base station apparatus 820 includes a controller 821, a memory 822, a network interface 823, and a radio communication interface 825.

The controller 821 may be, for example, a CPU or a DSP, and operates various functions of a higher layer of the base station apparatus 820. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as resource control, radio bearer control, mobility management, admission control and scheduling. The control may be performed in corporation with an eNB or a core network node in the vicinity. The memory 822 includes a RAM and a ROM, and stores a program executed by the controller 821 and various types of control data (such as a terminal list, transmission power data and scheduling data).

The network interface 823 is a communication interface for connecting the base station apparatus 820 to a core network 824. The controller 821 may communicate with a core network node or another eNB via the network interface 823. In this case, the eNB 800, and the core network node or another eNB may be connected to each other via a logic interface (such as an S1 interface and an X2 interface). The network interface 823 may also be a wired communication interface or a wireless communication interface for wireless backhaul. In a case that the network interface 823 is a wireless communication interface, the network interface 823 may use a higher frequency band for wireless communication than that used by the radio communication interface 825.

The radio communication interface 825 supports any cellular communication scheme (such as Long Term Evolution (LTE) and LTE-advanced), and provides wireless connection to a terminal located in a cell of the eNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and perform various types of signal processing of layers (such as L1, Media Access Control (MAC), Radio Link Control (RLC), and a Packet Data Convergence Protocol (PDCP)). The BB processor 826 may have a part or all of the above-described logical functions, to replace the controller 821. The BB processor 826 may be a memory storing communication control programs, or a module including a processor and a related circuit configured to execute the programs. Updating the program may allow the functions of the BB processor 826 to be changed. The module may be a card or a blade inserted into a slot of the base station apparatus 820. Alternatively, the module may be a chip mounted on the card or the blade. Meanwhile, the RF circuit 827 may include, for example, a mixer, a filter, and an amplifier, and transmits and receives wireless signals via the antenna 810.

As illustrated in FIG. 20, the radio communication interface 825 may include multiple BB processors 826. For example, the multiple BB processors 826 may be compatible with multiple frequency bands used by the eNB 800. The radio communication interface 825 may include multiple RF circuits 827, as illustrated in FIG. 20. For example, the multiple RF circuits 827 may be compatible with multiple antenna elements. Although FIG. 20 illustrates the example in which the radio communication interface 825 includes multiple BB processors 826 and multiple RF circuits 827, the radio communication interface 825 may include a single BB processor 826 and a single RF circuit 827.

In the eNB 800 shown in FIG. 20, the communication unit 102 and the transceiver of the electronic apparatus 100 may be implemented by the radio communication interface 825. At least part of the functions may also be implemented by the controller 821. For example, the controller 821 may determine a beam combination scanning indicator and perform beam scanning based on the beam combination scanning indicator by performing functions of the determination unit 101 and the communication unit 202, reducing the overload and delay caused by the beam scanning and improving the communication quality of the UE.

### Second Application Example

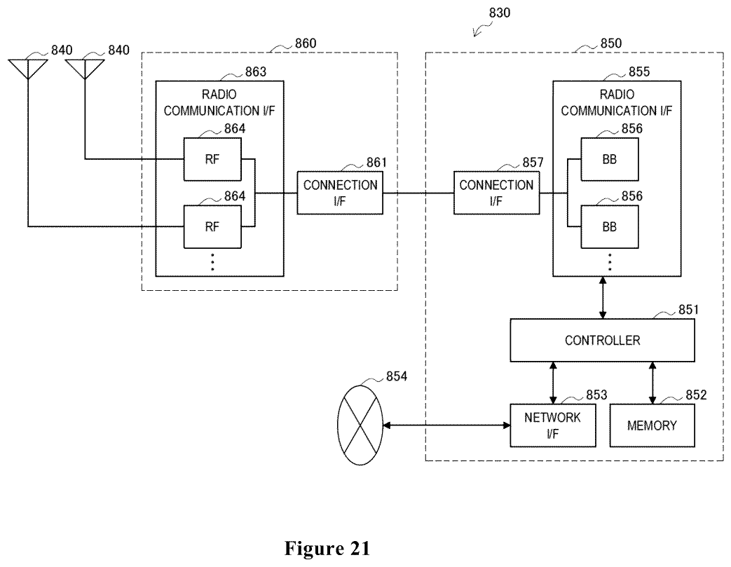

FIG. 21 is a block diagram illustrating a second example of an exemplary configuration of an eNB or gNB to which the technology according to the present disclosure may be applied. It should be noted that the following description is given by taking the eNB as an example, which is also applied to the gNB. An eNB 830 includes one or more antennas 840, a base station apparatus 850, and an RRH 860. The RRH 860 and each of the antennas 840 may be connected to each other via an RF cable. The base station apparatus 850 and the RRH 860 may be connected to each other via a high speed line such as an optical fiber cable.

Each of the antennas 840 includes a single or multiple antennal elements (such as multiple antenna elements included in an MIMO antenna), and is used for the RRH 860 to transmit and receive wireless signals. As illustrated in FIG. 21, the eNB 830 may include multiple antennas 840. For example, the multiple antennas 840 may be compatible with multiple frequency bands used by the eNB 830. Although FIG. 21 illustrates the example in which the eNB 830 includes multiple antennas 840, the eNB 830 may include a single antenna 840.

The base station apparatus 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 20.

The radio communication interface 855 supports any cellular communication scheme (such as LTE and LTE-advanced), and provides wireless communication to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 20, except that the BB processor 856 is connected to an RF circuit 864 of the RRH 860 via the connection interface 857. As illustrated in FIG. 21, the radio communication interface 855 may include multiple BB processors 856. For example, the multiple BB processors 856 may be compatible with multiple frequency bands used by the eNB 830. Although FIG. 21 illustrates the example in which the radio communication interface 855 includes multiple BB processors 856, the radio communication interface 855 may include a single BB processor 856.

The connection interface 857 is an interface for connecting the base station apparatus 850 (radio communication interface 855) to the RRH 860. The connection interface 857 may also be a communication module for communication in the above-described high speed line that connects the base station apparatus 850 (radio communication interface 855) to the RRH 860.

The RRH 860 includes a connection interface 861 and a radio communication interface 863.

The connection interface 861 is an interface for connecting the RRH 860 (radio communication interface 863) to the base station apparatus 850. The connection interface 861 may also be a communication module for communication in the above-described high speed line.

The radio communication interface 863 transmits and receives wireless signals via the antenna 840. The radio communication interface 863 may typically include, for example, an RF circuit 864. The RF circuit 864 may include, for example, a mixer, a filter and an amplifier, and transmits and receives wireless signals via the antenna 840. The radio communication interface 863 may include multiple RF circuits 864, as illustrated in FIG. 21. For example, the multiple RF circuits 864 may support multiple antenna elements. Although FIG. 21 illustrates the example in which the radio communication interface 863 includes multiple RF circuits 864, the radio communication interface 863 may include a single RF circuit 864.

In the eNB 830 shown in FIG. 21, the communication unit 102 and the transceiver of the electronic apparatus 100 may be implemented by the radio communication interface 855 and/or the radio communication interface 863. At least part of the functions may also be implemented by the controller 851. For example, the controller 851 may determine a beam combination scanning indicator and perform beam scanning based on the beam combination scanning indicator by performing functions of the determination unit 101 and the communication unit 202, reducing the overload and delay caused by the beam scanning and improving the communication quality of the UE.

### Application Examples of User Equipment

### First Application Example

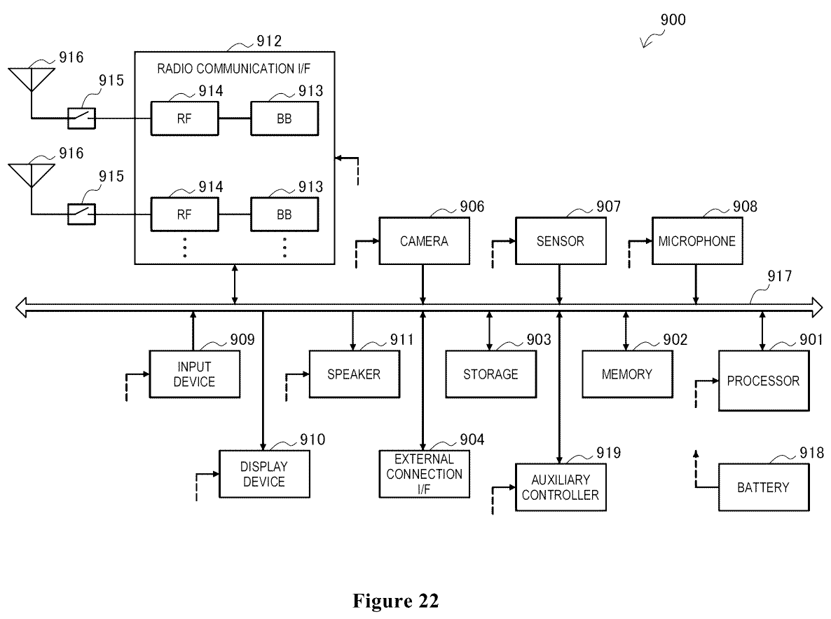

FIG. 22 is a block diagram illustrating an exemplary configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes a RAM and a ROM, and stores a program executed by the processor 901 and data. The storage 903 may include a storage medium such as a semiconductor memory and a hard disk. The external connection interface 904 is an interface for connecting an external device (such as a memory card and a universal serial bus (USB) device) to the smartphone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetism sensor, and an acceleration sensor. The microphone 908 converts sounds inputted to the smartphone 900 to audio signals. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The speaker 911 converts audio signals outputted from the smartphone 900 to sounds.

The radio communication interface 912 supports any cellular communication scheme (such as LTE and LTE-advanced), and performs wireless communications. The radio communication interface 912 may include, for example, a BB processor 913 and an RF circuit 914. The BB processor 913 may perform, for example, encoding/decoding, modulating/demodulating, and multiplexing/de-multiplexing, and perform various types of signal processing for wireless communication. The RF circuit 914 may include, for example, a mixer, a filter and an amplifier, and transmits and receives wireless signals via the antenna 916. It should be noted that although FIG. 22 illustrates a case that one RF link is connected to one antenna, which is only illustrative, and a situation where one RF link is connected to multiple antennas through multiple phase shifters is also possible. The radio communication interface 912 may be a chip module having the BB processor 913 and the RF circuit 914 integrated thereon. The radio communication interface 912 may include multiple BB processors 913 and multiple RF circuits 914, as illustrated in FIG. 22. Although FIG. 22 illustrates the example in which the radio communication interface 912 includes multiple BB processors 913 and multiple RF circuits 914, the radio communication interface 912 may include a single BB processor 913 or a single RF circuit 914.

Furthermore, in addition to a cellular communication scheme, the radio communication interface 912 may support another type of wireless communication scheme such as a short-distance wireless communication scheme, a near field communication scheme, and a wireless local area network (LAN) scheme. In this case, the radio communication interface 912 may include the BB processor 913 and the RF circuit 914 for each wireless communication scheme.

Each of the antenna switches 915 switches connection destinations of the antennas 916 among multiple circuits (such as circuits for different wireless communication schemes) included in the radio communication interface 912.

Each of the antennas 916 includes a single or multiple antenna elements (such as multiple antenna elements included in an MIMO antenna) and is used for the radio communication interface 912 to transmit and receive wireless signals. The smartphone 900 may include the multiple antennas 916, as illustrated in FIG. 22. Although FIG. 22 illustrates the example in which the smartphone 900 includes multiple antennas 916, the smartphone 900 may include a single antenna 916.

Furthermore, the smartphone 900 may include the antenna 916 for each wireless communication scheme. In this case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smartphone 900 illustrated in FIG. 22 via feeder lines, which are partially illustrated as dashed lines in FIG. 22. The auxiliary controller 919 operates a minimum necessary function of the smartphone 900, for example, in a sleep mode.

In the smartphone 900 shown in FIG. 22, the communication unit 201 and the transceiver of the electronic apparatus 200 may be implemented by the radio communication interface 912. At least part of the functions may also be implemented by the processor 901 or the auxiliary controller 919. For example, the processor 901 or the auxiliary controller 919 may assist a base station to determine a beam combination scanning indicator and perform beam scanning based on the beam combination scanning indicator by implementing the functions of the communication unit 201 and the measurement unit 202, thereby reducing the overload and delay caused by the beam scanning and improving the communication quality of the UE.

### Second Application Example

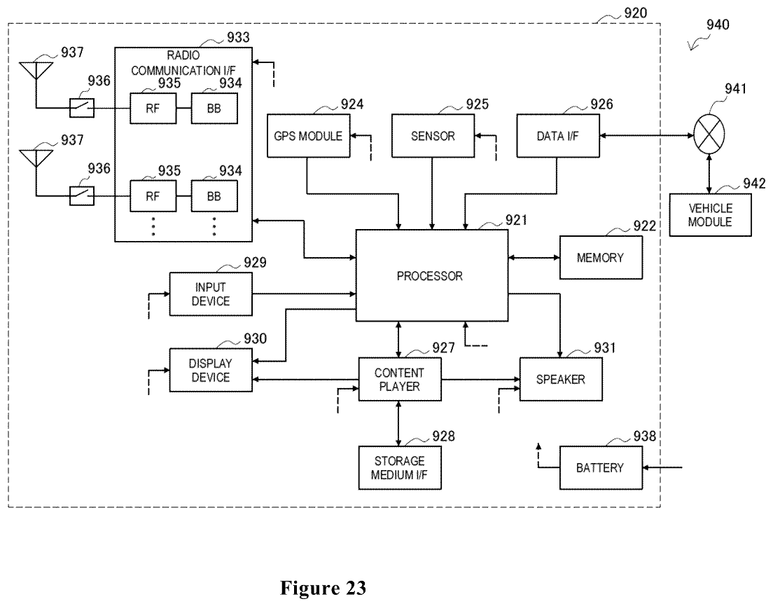

FIG. 23 is a block diagram illustrating an example of a schematic configuration of a car navigation apparatus 920 to which the technology according to the present disclosure may be applied. The car navigation apparatus 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example a CPU or a SoC, and controls a navigation function and additional function of the car navigation apparatus 920. The memory 922 includes RAM and ROM, and stores a program executed by the processor 921, and data.

The GPS module 924 determines a position (such as latitude, longitude and altitude) of the car navigation apparatus 920 by using GPS signals received from a GPS satellite. The sensor 925 may include a group of sensors such as a gyro sensor, a geomagnetic sensor and an air pressure sensor. The data interface 926 is connected to, for example, an in-vehicle network 941 via a terminal that is not illustrated, and acquires data (such as vehicle speed data) generated by the vehicle.

The content player 927 reproduces content stored in a storage medium (such as a CD and DVD) that is inserted into the storage medium interface 928. The input device 929 includes, for example, a touch sensor configured to detect touch onto a screen of the display device 930, a button, or a switch, and receives an operation or information inputted from a user. The display device 930 includes a screen such as an LCD or OLED display, and displays an image of the navigation function or reproduced content. The speaker 931 outputs a sound for the navigation function or the reproduced content.

The radio communication interface 933 supports any cellular communication scheme (such as LTE and LTE-Advanced), and performs wireless communication. The radio communication interface 933 may typically include, for example, a BB processor 934 and an RF circuit 935. The BB processor 934 may perform, for example, encoding/decoding, modulating/demodulating and multiplexing/demultiplexing, and perform various types of signal processing for wireless communication. The RF circuit 935 may include, for example, a mixer, a filter and an amplifier, and transmits and receives wireless signals via the antenna 937. The radio communication interface 933 may also be a chip module having the BB processor 934 and the RF circuit 935 integrated thereon. The radio communication interface 933 may include multiple BB processors 934 and multiple RF circuits 935, as illustrated in FIG. 23. Although FIG. 23 illustrates the example in which the radio communication interface 933 includes multiple BB processors 934 and multiple RF circuits 935, the radio communication interface 933 may include a single BB processor 934 and a single RF circuit 935.

Furthermore, in addition to a cellular communication scheme, the radio communication interface 933 may support another type of wireless communication scheme such as a short-distance wireless communication scheme, a near field communication scheme, and a wireless LAN scheme. In this case, the radio communication interface 933 may include the BB processor 934 and the RF circuit 935 for each wireless communication scheme.

Each of the antenna switches 936 switches connection destinations of the antennas 937 among multiple circuits (such as circuits for different wireless communication schemes) included in the radio communication interface 933.

Each of the antennas 937 includes a single or multiple antenna elements (such as multiple antenna elements included in an MIMO antenna), and is used for the radio communication interface 933 to transmit and receive wireless signals. As illustrated in FIG. 23, the car navigation apparatus 920 may include multiple antennas 937. Although FIG. 23 illustrates the example in which the car navigation apparatus 920 includes multiple antennas 937, the car navigation apparatus 920 may include a single antenna 937.

Furthermore, the car navigation apparatus 920 may include the antenna 937 for each wireless communication scheme. In this case, the antenna switches 936 may be omitted from the configuration of the car navigation apparatus 920.

The battery 938 supplies power to the blocks of the car navigation apparatus 920 illustrated in FIG. 23 via feeder lines that are partially illustrated as dash lines in FIG. 23. The battery 938 accumulates power supplied from the vehicle.

In the car navigation apparatus 920 shown in FIG. 23, the communication unit 201 and the transceiver of the electronic apparatus 200 may be implemented by the radio communication interface 933. At least part of the functions may also be implemented by the processor 921. For example, the processor 921 may assist a base station to determine a beam combination scanning indicator and perform beam scanning based on the beam combination scanning indicator by implementing the functions of the communication unit 201 and the measurement unit 202, thereby reducing the overload and delay caused by the beam scanning and improving the communication quality of the UE.

The technology according to the present disclosure may also be implemented as an in-vehicle system (or a vehicle) 940 including one or more blocks of the car navigation device 920, the in-vehicle network 941, and a vehicle module 942. The vehicle module 942 generates vehicle data (such as vehicle speed, engine speed, and failure information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

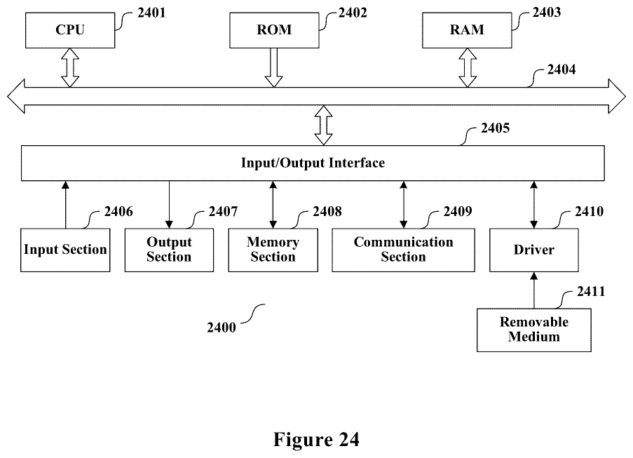

In the case where the present disclosure is realized with software or firmware, a program constituting the software is installed in a computer with a dedicated hardware structure (e.g. the general computer 2400 shown in FIG. 24) from a storage medium or network, wherein the computer is capable of implementing various functions when installed with various programs.

In FIG. 24, a central processing unit (CPU) 2401 executes various processing according to a program stored in a read-only memory (ROM) 2402 or a program loaded to a random access memory (RAM) 2403 from a memory section 2408. The data needed for the various processing of the CPU 2401 may be stored in the RAM 2403 as needed. The CPU 2401, the ROM 2402 and the RAM 2403 are linked with each other via a bus 2404. An input/output interface 2405 is also linked to the bus 2404.

The following components are linked to the input/output interface 2405: an input section 2406 (including keyboard, mouse and the like), an output section 2407 (including displays such as a cathode ray tube (CRT), a liquid crystal display (LCD), a loudspeaker and the like), a memory section 2408 (including hard disc and the like), and a communication section 2409 (including a network interface card such as a LAN card, modem and the like). The communication section 2409 performs communication processing via a network such as the Internet. A driver 2410 may also be linked to the input/output interface 2405, if needed. If needed, a removable medium 2411, for example, a magnetic disc, an optical disc, a magnetic optical disc, a semiconductor memory and the like, may be installed in the driver 2410, so that the computer program read therefrom is installed in the memory section 2408 as appropriate.

In the case where the foregoing series of processing is achieved through software, programs forming the software are installed from a network such as the Internet or a memory medium such as the removable medium 2411.

It should be appreciated by those skilled in the art that the memory medium is not limited to the removable medium 2411 shown in FIG. 24, which has program stored therein and is distributed separately from the apparatus so as to provide the programs to users. The removable medium 2411 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 2402 and the memory section 2408 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
processing circuitry, configured to:
determine, at least based on mobility information of user equipment (UE), a beam combination scanning indicator which is used to indicate multiple beam combinations arranged in sequence, wherein each beam combination comprises a direct beam which is emitted from a base station to the UE and a reflected beam which is reflected by a large intelligent surface (LIS) toward the UE; and
provide the beam combination scanning indicator to the UE, so that the UE performs beam combination measurement based on the beam combination scanning indicator.

2. The electronic apparatus according to claim 1, wherein the processing circuitry is further configured to acquire the mobility information from the UE, wherein the mobility information at least comprises a movement direction of the UE, and
wherein the mobility information further comprises a movement speed of the UE.

3. (canceled)

4. The electronic apparatus according to claim 2, wherein the processing circuitry is further configured to determine, based on the mobility information, whether the UE is to deviate from a current beam serving range, and determine to update a beam in a case of determining that the UE is to deviate from the current beam serving range, wherein updating the beam comprises updating the direct beam and/or the reflected beam; and/or
wherein the processing circuitry is configured to acquire the mobility information periodically from the UE.

5. (canceled)

6. The electronic apparatus according to claim 2, wherein the processing circuitry is further configured to acquire a beam updating request from the UE, and determine to update a beam in response to the beam updating request, wherein updating the beam comprises updating the direct beam and/or the reflected beam.

7. The electronic apparatus according to claim 1, wherein the processing circuitry is further configured to control the base station and the LIS to perform scanning of beam combinations of the direct beams and the reflected beams according to the beam combination scanning indicator.

8. The electronic apparatus according to claim 7, wherein the processing circuitry is further configured to acquire, from the UE, information of a feedback beam combination determined by the UE through measurement on the beam combinations; and/or
wherein the processing circuitry is further configured to determine, based on the information of the feedback beam combination, a beam combination to be used by the UE after beam updating, and control, based on the beam combination, a direction of the direct beam from the base station and a direction of the reflected beam from the LIS.

9. The electronic apparatus according to claim 8, wherein the feedback beam combination comprises one of the following: an optimal beam combination; and a beam combination of which communication quality meets a predetermined requirement; and/or
wherein the processing circuitry is further configured to acquire the information of the feedback beam combination through a physical uplink control channel or MAC CE.

10. (canceled)

11. The electronic apparatus according to claim 9, wherein the processing circuitry is configured to acquire the information of the feedback beam combination in an explicit manner or an implicit manner.

12. The electronic apparatus according to claim 11, wherein the processing circuitry is configured to determine the information of the feedback beam combination based on a time instant at which the UE transmits feedback.

13. (canceled)

14. The electronic apparatus according to claim 1, further comprising a memory, configured to store a correspondence among a movement direction of the UE, a to-be-scanned beam and a current beam, and wherein the processing circuitry is configured to determine the beam combination scanning indicator based on the mobility information and the correspondence.

15. The electronic apparatus according to claim 1, wherein the processing circuitry is further configured to determine whether a direct link between the base station and the UE shares same time-frequency resources with a reflective link via the LIS between the base station and the UE, and
determine the beam combination scanning indicator such that the UE performs beam scanning just for a link with reduced receiving power, in a case of determining that the direct link does not share the same time-frequency resources with the reflective link.

16. The electronic apparatus according to claim 1, wherein the processing circuitry is further configured to determine whether the UE is served by multiple cells, and cooperate with a base station for another cell to perform synchronous transmission and perform beam combination scanning respectively, in a case of determining that the UE is served by multiple cells, and wherein the processing circuitry is configured to interchange the beam combination scanning indicator with the base station for the other cell.

17. The electronic apparatus according to claim 1, wherein the beam combination scanning indicator comprises a scanning sequence list of beam combinations,
in a case that the UE is served by a single cell, each entry in the scanning sequence list of beam combinations comprises a beam index of a direct beam and a beam index of a reflected beam, and
in a case that the UE is served by multiple cells, each entry in the scanning sequence list of beam combinations comprises a beam index of a direct beam, a beam index of a reflected beam, and information of an identifier of a corresponding cell.

18. An electronic apparatus for wireless communications, comprising:
processing circuitry, configured to:
receive, from a base station, a beam combination scanning indicator which is used to indicate multiple beam combinations arranged in sequence, wherein each beam combination comprises a direct beam which is emitted from the base station to UE and a reflected beam which is reflected by a large intelligent surface (LIS) toward the UE; and
perform beam combination measurement based on the beam combination scanning indicator.

19. The electronic apparatus according to claim 18, wherein the processing circuitry is further configured to report mobility information to the base station, so that the base station determines the beam combination scanning indicator at least based on the mobility information, wherein the mobility information at least comprises a movement direction of the UE, and
wherein the mobility information further comprises a movement speed of the UE.

20.-21. (canceled)

22. The electronic apparatus according to claim 19, wherein the processing circuitry is further configured to transmit a beam updating request to the base station in a case that communication quality falls to a predetermined degree, to request the base station to update a beam, wherein updating the beam comprises updating the direct beam and/or the reflected beam.

23. The electronic apparatus according to claim 18, wherein the processing circuitry is further configured to provide, to the base station, information of a feedback beam combination determined through measurement on the beam combinations, and/or
wherein the feedback beam combination comprises one of the following: an optimal beam combination; and a beam combination of which communication quality meets a predetermined requirement, and/or
wherein the processing circuitry is further configured to provide the information of the feedback beam combination through a physical uplink control channel or MAC CE, and/or
wherein the processing circuitry is configured to provide the information of the feedback beam combination in an explicit manner or an implicit manner.

24.-28. (canceled)

29. The electronic apparatus according to claim 18, wherein in a case that the UE is served by multiple cells, the processing circuitry is configured to perform beam combination measurement for each of the cells, based on the beam combination scanning indicator from the cell, respectively.

30. The electronic apparatus according to claim 29, wherein in a case that beam scanning for the multiple cells shares the same time-frequency resources, the processing circuitry is configured to measure a combined receiving power of multiple beam combinations of the multiple cells.

31. (canceled)

32. A method for wireless communications, comprising:
determining, at least based on mobility information of user equipment (UE), a beam combination scanning indicator which is used to indicate multiple beam combinations arranged in sequence, wherein each beam combination comprises a direct beam which is emitted from a base station to the UE and a reflected beam which is reflected by a large intelligent surface (LIS) toward the UE; and
providing the beam combination scanning indicator to the UE, so that the UE performs beam combination measurement based on the beam combination scanning indicator.

33.-34. (canceled)
